(19) United States
(12) Patent Application Publication
(10) Pub. No.: US 2026/0125002 A1
(43) Pub. Date: May 7, 2026

(54) LUGGAGE SIDE TRIM

(71) Applicant: KASAI KOGYO CO., LTD., Kanagawa (JP)

(72) Inventors: Ichiro FUKUMOTO, Tokyo (JP); Tomohiro TSUIKI, Tokyo (JP); Yuki DOI, Kanagawa (JP)

(21) Appl. No.: 19/425,406

(22) Filed: Dec. 18, 2025

Related U.S. Application Data
(63) Continuation of application No. PCT/JP2023/025388, filed on Jul. 10, 2023.

(51) Int. Cl. B60R 13/08; B60R 5/04

(52) U.S. Cl. CPC B60R 13/08; B60R 5/04

(57) ABSTRACT

A luggage side trim includes: an interior-side front surface layer included in an interior-side surface; a panel-side back surface layer that is included in a surface on a side of an inner panel and has an edge that is fixed to the interior-side front surface layer; and an intermediate air layer interposed between the interior-side front surface layer and the panel-side back surface layer, in which the panel-side back surface layer is a molded article including a layer of an air-permeable base material.

### CROSS-REFERENCE TO RELATED APPLICATIONS

This application is a continuation application of PCT International Application No. PCT/JP2023/025388, filed on July 10, 2023, the entire contents of which are hereby incorporated by reference.

### BACKGROUND

### 1. Technical Field

The present invention relates to a luggage side trim.

### 2. Description of the Background

A soundproof structure that reduces vehicle cabin noise caused by road noise (e.g. see JP-2008-162549-A, hereinafter referred to as Patent Literature 1), a sound absorbing structure that reduces noise propagated from an extractor opening through a ventilation space into a vehicle cabin (e.g. see JP-2018-202991-A, hereinafter referred to as Patent Literature 2), and the like are known. In the soundproof structure described in Patent Literature 1, a felt material is fixed to a wheelhouse panel, and a sponge material is fixed to an inner panel. In addition, in the sound absorbing structure described in Patent Literature 2, a sound absorbing member is disposed between a ventilation opening and the extractor opening (drafter) so as to surround the entire circumference of the ventilation space.

### BRIEF SUMMARY

In the soundproof/sound absorbing structures described in Patent Literatures 1 and 2, the thickness, air permeability, area density, and the like of the sound absorbing members such as the felt material attached to a panel, a trim, and the like are uniform.

In contrast, the frequency band of radiated sound having been transmitted through a wheelhouse panel or a drafter varies depending on conditions such as the presence or absence of an opening of an inner panel. Accordingly, the soundproof/sound absorbing structures described in Patent Literatures 1 and 2 cannot sufficiently achieve effects such as sound absorption, sound insulation, and distance-based attenuation with respect to radiated sound having been transmitted through a wheelhouse panel or a drafter.

The present invention has been made in view of such circumstances, and an object thereof is to provide a luggage side trim that can effectively reduce the propagation, into a vehicle cabin, of noise that is generated around a luggage compartment such as radiated sound having been transmitted through a wheelhouse panel, a drafter, or the like.

A luggage side trim according to the present invention includes: an interior-side front surface layer included in an interior-side surface; a panel-side back surface layer that is included in a surface on a side of an inner panel and has an edge that is fixed to the interior-side front surface layer; and an air layer interposed between the interior-side front surface layer and the panel-side back surface layer, in which the panel-side back surface layer is a molded article including a layer of an air-permeable base material.

The present invention can provide a luggage side trim that can effectively reduce the propagation, into a vehicle cabin, of noise that is generated around a luggage compartment such as radiated sound having been transmitted through a wheelhouse panel, a drafter, or the like.

### BRIEF DESCRIPTION OF DRAWINGS

FIG. 1 is a cross-sectional view illustrating a luggage side trim and the body structure of a vehicle according to one embodiment of the present invention as seen from the rear side of the vehicle.

FIG. 2 is an enlarged cross-sectional view of the luggage side trim illustrated in FIG. 1.

FIG. 3 is a graph representing the relationship between the noise levels in the vicinity of an opening of an inner panel and the vicinity of a wheelhouse panel and 1/3 octave band center frequency.

FIG. 4 is a cross-sectional view illustrating an overview of a first specimen for checking the performance of the luggage side trim.

FIG. 5 is a cross-sectional view illustrating an overview of a second specimen for checking the performance of the luggage side trim.

FIG. 6 is a graph representing the relationship between the transmission loss in the vicinity of the opening of the inner panel in cases where the first specimen and the second specimen are disposed in the vicinity of the opening of the inner panel and 1/3 octave band center frequency.

FIG. 7 is a graph representing the relationship between the normal incidence sound absorption coefficient in the vicinity of the wheelhouse panel in cases where the first specimen and the second specimen are disposed in the vicinity of the wheelhouse panel and 1/3 octave band center frequency.

FIG. 8 is a cross-sectional view illustrating a modification example of a panel-side back surface layer.

FIG. 9 is a cross-sectional view illustrating a modification example of the panel-side back surface layer.

FIG. 10 is a cross-sectional view illustrating a modification example of the panel-side back surface layer.

FIG. 11 is a cross-sectional view illustrating a modification example of the panel-side back surface layer.

FIG. 12 is a cross-sectional view illustrating a modification example of the panel-side back surface layer.

FIG. 13 is a cross-sectional view illustrating a modification example of the panel-side back surface layer.

FIG. 14 is a cross-sectional view illustrating a modification example of the panel-side back surface layer.

FIG. 15 is a cross-sectional view illustrating a modification example of the panel-side back surface layer.

FIG. 16 is a cross-sectional view illustrating a modification example of the panel-side back surface layer.

FIG. 17 is a cross-sectional view illustrating a luggage side trim and the body structure of the vehicle according to another embodiment according to the present invention as seen from the rear side of the vehicle.

FIG. 18 is an enlarged cross-sectional view of the luggage side trim illustrated in FIG. 17.

### DETAILED DESCRIPTION

Hereinbelow, the present invention is explained in accordance with suitable embodiments. Note that the present invention is not limited to the embodiments illustrated below, but can be modified as appropriate within the scope not departing from the spirit of the present invention. In addition, although there are portions in the embodiments illustrated below where the illustration or explanation of some constituent elements is omitted, known or well-known technologies are applied as appropriate to omitted technological details within such a scope that contradictions with the content explained below do not arise.

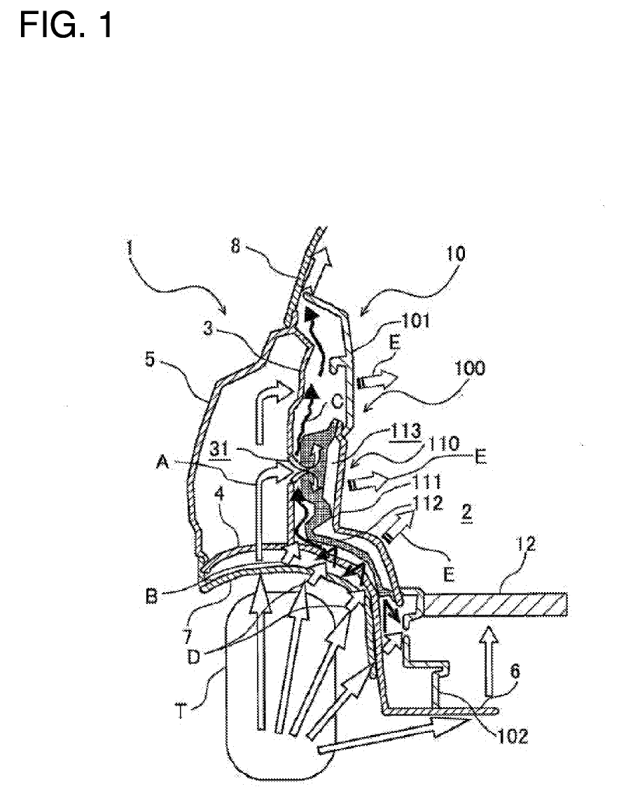

FIG. 1 is a cross-sectional view illustrating a luggage side trim 100 and the body structure of a vehicle 1 according to one embodiment of the present invention as seen from the rear side of the vehicle. As illustrated in the drawing, a luggage compartment 2 of the vehicle 1 includes a luggage trim 10.

The luggage trim 10 includes a luggage board trim 12, the luggage side trim 100, and an unillustrated luggage floor under-box. The luggage floor under-box is laid down in the bottom surface of the luggage compartment 2. In addition, the luggage board trim 12 is laid down in the upper surface of the luggage floor under-box.

The luggage side trim 100 is disposed in the luggage compartment 2 so as to cover an inner panel 3 included in the side wall of the luggage compartment 2 and a part of a wheelhouse panel 4. The luggage side trim 100 includes an upper luggage side trim 101, a lower luggage side trim 110, and a luggage-side-trim bottom 102. The lower end of the upper luggage side trim 101 and the upper end of the lower luggage side trim 110 engage with each other, and the lower end of the lower luggage side trim 110 and the upper end of the luggage-side-trim bottom 102 engage with each other. Thereby, the luggage side trim 100 in which the upper luggage side trim 101, the lower luggage side trim 110, and the luggage-side-trim bottom 102 are integrated is formed. Note that the luggage side trim 100 may have configuration in which all of the upper luggage side trim 101, the lower luggage side trim 110, and the luggage-side-trim bottom 102 are integrally molded or may have configuration in which some of them are partially integrally molded and engage with each other.

The upper luggage side trim 101 is a cover member that covers the upper side of the inner panel 3. There is a space between the luggage side trim 101 and the inner panel 3, and there is a gap between the upper end of the luggage side trim 101 and a window glass 8. Note that the upper end of the luggage side trim 101 may engage with a pillar that serves as a path connected to the ceiling.

The lower luggage side trim 110 is a cover member that covers the lower side of the inner panel 3 and a part of the wheelhouse panel 4. The luggage side trim 110 has a triple-layer structure including an interior-side front surface layer 111, a panel-side back surface layer 112, and an intermediate air layer 113. The outer circumferential edge of the interior-side front surface layer 111 and the outer circumferential edge of the panel-side back surface layer 112 are fixed, and the intermediate air layer 113 is formed between the interior-side front surface layer 111 and the panel-side back surface layer 112. Note that examples of the fixation method include pasting using an adhesive, welding by melting the base materials using heat or vibration, and the like. It is sufficient if fixation by adhesion, welding, or the like is performed over the entire circumference or partially, and, in a case where fixation by adhesion, welding, or the like is performed partially, the remaining portion may be fixed by engagement using claws.

The interior-side front surface layer 111 is included in the front surface of the luggage side trim 100 together with the upper luggage side trim 101. The upper side of the interior-side front surface layer 111 faces the inner panel 3 with the upper side of the panel-side back surface layer 112 being interposed therebetween. In addition, the lower side of the interior-side front surface layer 111 faces the wheelhouse panel 4 with the lower side of the panel-side back surface layer 112 being interposed therebetween. Note that the lower side of the interior-side front surface layer 111 may contact or cover the wheelhouse panel 4. In addition, the lower side of the interior-side front surface layer 111 is curved along the curved shape of the wheelhouse panel 4.

The upper side of the panel-side back surface layer 112 faces the lower side of the inner panel 3 across a space. In addition, the lower side of the panel-side back surface layer 112 faces the wheelhouse panel 4 across a space. In addition, the lower side of the panel-side back surface layer 112 is curved along the curved shape of the wheelhouse panel 4. Note that the lower side of the panel-side back surface layer 112 may partially or entirely contact or cover the wheelhouse panel 4.

The body structure of the vehicle 1 includes the inner panel 3, the wheelhouse panel 4, an outer panel 5, a floor panel 6, a fender liner 7, and the window glass 8. The lower end of the inner panel 3 and the middle section of the wheelhouse panel 4 in the vehicle-width direction are joined. In addition, the upper end of the inner panel 3 and the upper end of the outer panel 5 are joined. In addition, the lower end of the outer panel 5 and the outer end of the wheelhouse panel 4 in the vehicle-width direction are joined. In addition, the outer end of the floor panel 6 in the vehicle-width direction and the inner end of the wheelhouse panel 4 in the vehicle-width direction are joined. Furthermore, the fender liner 7 is attached to the wheelhouse panel 4 so as to cover the front surface of the wheelhouse panel 4.

An opening 31 such as a wire insertion hole or a ventilation hole is formed through the inner panel 3. The opening 31, which is used as a wire insertion hole, a ventilation hole, or the like, is not allowed to be blocked with the luggage side trim 100. Because of this, as represented by an arrow A, panel-radiated sound (sound transmitted through the wheelhouse panel 4) caused by road noise of a tire T enters the space between the inner panel 3 and the luggage side trim 100 through the opening 31. In addition, as represented by an arrow B, the panel-radiated sound directly enters the space between the inner panel 3 and the luggage side trim 100. Then, as represented by an arrow C, the panel-radiated sound having entered the space between the inner panel 3 and the luggage side trim 100 is propagated between the inner panel 3 and the luggage side trim 100 and enters the vehicle cabin from the gap between the upper luggage side trim 101 and the window glass 8.

In addition, as represented by arrows D, the panel-radiated sound enters the space between the wheelhouse panel 4 and the luggage side trim 100. In addition, as represented by arrows E, the panel-radiated sound having entered the space between the inner panel 3 and the luggage side trim 100 and between the wheelhouse panel 4 and the luggage side trim 100 is transmitted through the luggage side trim 100 and enters the vehicle cabin.

In view of this, in the present embodiment, the lower luggage side trim 110 that achieves effects such as sound absorption, sound insulation, and attenuation with respect to the sound propagated between the inner panel 3 and the luggage side trim 100 and the sound transmitted through the luggage side trim 100 is provided. Hereinbelow, the configuration and effects of the luggage side trim 110 are explained.

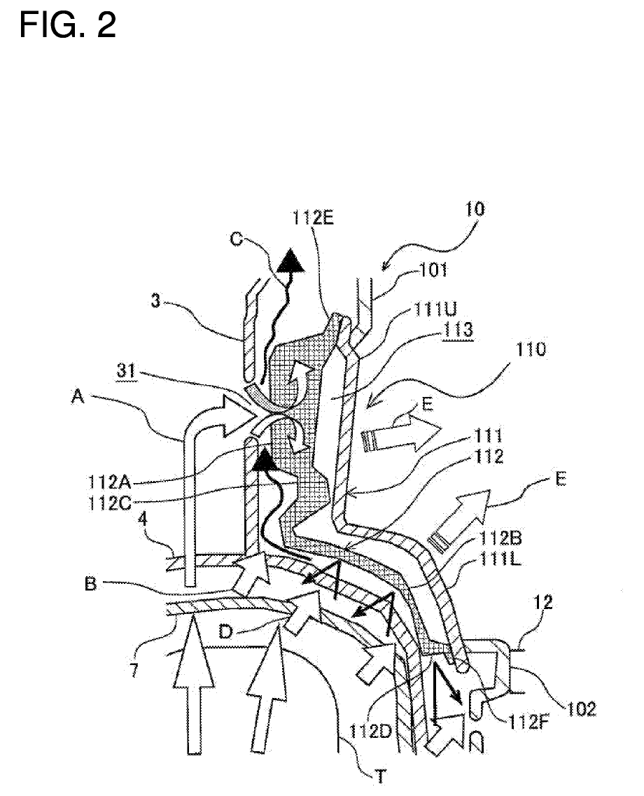

FIG. 2 is an enlarged cross-sectional view of the luggage side trim 110 illustrated in FIG. 1. The interior-side front surface layer 111 of the luggage side trim 110 illustrated in the drawing is a molded article formed using one or more layers of an air-impermeable base material. Examples of the air-impermeable base material include resin materials such as polypropylene, composite materials including resin and fiber, and the like. In addition, examples of the molding method for the air-impermeable base material include injection molding, cold pressing, and the like.

Note that the interior-side front surface layer 111 may be formed using an air-permeable base material (porous body). In addition, the front surface or back surface of the interior-side front surface layer 111 may be provided with a non-woven fabric, a film, a sheet, or the like. Examples of the air-permeable base material include a molded non-woven fabric, a felt, glass wool, urethane, and the like. In addition, the molding method for the air-permeable base material include cold pressing, hot pressing, and the like.

The panel-side back surface layer 112 of the luggage side trim 110 is a molded article formed using one or more layers of an air-permeable base material (porous body). Examples of the air-permeable base material include a molded non-woven fabric, a felt, glass wool, urethane, and the like. In addition, the molding method for the air-permeable base material include cold pressing, hot pressing, and the like.

The air permeability of the panel-side back surface layer 112 is preferably 1 to 60 cm³/cm²⋅SEC and is more preferably 5 to 30 cm³/cm²⋅SEC. In addition, the thickness of the panel-side back surface layer 112 is preferably 2 to 100 mm and is more preferably 3 to 25mm. In addition, the area density of the panel-side back surface layer 112 is preferably 200 to 2500 g/m² and is more preferably 600 to 1400 g/m². Note that the front surface or back surface of the panel-side back surface layer 112 may be provided with a non-woven fabric, a film, a sheet, or the like.

The thickness of the intermediate air layer 113 of the luggage side trim 110 is preferably 0.1 to 200 mm and is more preferably 3 to 30 mm. In addition, examples of the fixation method for the interior-side front surface layer 111 and the panel-side back surface layer 112 include hot melt bonding, adhesion using an adhesive, ultrasonic welding, fixation by anchor effect, and the like.

The interior-side front surface layer 111 includes: an upper portion 111U that faces the inner panel 3 with the upper portion of the panel-side back surface layer 112 being interposed therebetween; and a lower portion 111L that faces the wheelhouse panel 4 with the lower portion of the panel-side back surface layer 112 being interposed therebetween. The opening 31 of the inner panel 3 faces the upper portion 111U with the upper portion of the panel-side back surface layer 112 being interposed therebetween. In addition, the lower portion 111L is curved along the curved shape of the wheelhouse panel 4.

The panel-side back surface layer 112 includes a sound absorbing section 112A, a first sound insulating section 112B, a distance-based attenuation section 112C, a second sound insulating section 112D, and fixing sections 112E and 112F. The sound absorbing section 112A is interposed between the upper portion 111U of the interior-side front surface layer 111 and the inner panel 3. The fixing section 112E fixes the outer circumferential edge of the sound absorbing section 112A and the outer circumferential edge of the upper portion 111U of the interior-side front surface layer 111. Note that it is sufficient if the fixation by the fixing section 112E is performed over the entire circumference or partially.

The first sound insulating section 112B is interposed between the lower portion 111L of the interior-side front surface layer 111 and the wheelhouse panel 4 and is curved along the curved shape of the wheelhouse panel 4. The distance-based attenuation section 112C is provided at the boundary between the sound absorbing section 112A and the first sound insulating section 112B and is interposed between the upper portion 111U of the interior-side front surface layer 111 and the inner panel 3.

The second sound insulating section 112D is provided at the lower end of the first sound insulating section 112B and is interposed between the lower portion 111L of the interior-side front surface layer 111 and the wheelhouse panel 4 so as to block the space between the lower portion 111L of the interior-side front surface layer 111 and the wheelhouse panel 4. The fixing section 112F fixes the edge of the second sound insulating section 112D and the outer circumferential edge of the lower portion 111L of the interior-side front surface layer 111. Note that it is sufficient if the fixation by the fixing section 112F is performed over the entire circumference or partially.

Here, the air permeability, thickness, and area density of each section of the panel-side back surface layer 112 differ. The sound absorbing section 112A, which is molded to have relatively large thickness in the range of, for example, 15 to 50mm, achieves relatively high air permeability and relatively low area density. In contrast, the first sound insulating section 112B and the second sound insulating section 112D, which are molded to have relatively small thickness in the range of, for example, 2 to 15 mm, achieve relatively low air permeability and relatively high area density.

The panel-side back surface layer 112 is a molded article molded by pressurizing and heating or pressurizing an air-permeable base material (porous body), and the air permeability, thickness, and area density of each section are adjusted by partially adjusting the pressure or amount of heat at the time of the molding. The sound absorbing section 112A is molded to have relatively large thickness by relatively reducing the pressure and amount of heat at the time of the molding, and the first sound insulating section 112B and the second sound insulating section 112D are molded to have relatively small thickness by relatively increasing the pressure and amount of heat at the time of the molding.

The distance-based attenuation section 112C has an uneven structure having a surface on the side of the inner panel 3 that is concave in a direction away from the inner panel 3 and a surface on the side of the interior-side front surface layer 111 that is protruding in a direction toward the interior-side front surface layer 111. Since the gap between the distance-based attenuation section 112C with the uneven structure and the upper portion 111U of the interior-side front surface layer 111 is narrow or absent, the intermediate air layer 113 is divided into two sections. Note that the sections of the intermediate air layer 113 may partially communicate with each other.

The sound absorbing section 112A, which is molded to have relatively large thickness, can provide an enhanced sound absorption effect as a porous body, the intermediate air layer 113, which functions as a rear air layer of the sound absorbing section 112A, and a sound absorption effect with respect to the panel-radiated sound entering the space between the inner panel 3 and the luggage side trim 110 through the opening 31 in the vicinity of the opening 31 of the inner panel 3 is achieved. In addition, due to the double-wall structure including the sound absorbing section 112A and the upper portion 111U of the interior-side front surface layer 111 with the intermediate air layer 113 (rear air layer) being interposed therebetween, sound transmitted through the luggage side trim 110 and propagated into the vehicle cabin is attenuated. Thereby, the propagation of noise in the mid- to high-frequency range in the vicinity of the opening 31 of the inner panel 3 into the vehicle cabin can be reduced. Note that details of the effect of reducing the propagation of noise in the mid- to high-frequency range in the vicinity of the opening 31 of the inner panel 3 into the vehicle cabin are mentioned later.

The first sound insulating section 112B, which is molded to have relatively small thickness, has lower air permeability and achieves a sound insulating effect with respect to the panel-radiated sound having been transmitted through the wheelhouse panel 4 in the vicinity of the wheelhouse panel 4, and the intermediate air layer 113, which functions as a rear air layer of the air-permeable first sound insulating section 112B, achieves also sound absorption performance. In addition, due to the double-wall structure including the first sound insulating section 112B and the lower portion 111L of the interior-side front surface layer 111 with the intermediate air layer 113, which is a rear air layer, being interposed therebetween, sound transmitted through the luggage side trim 110 and propagated into the vehicle cabin is attenuated. Thereby, the propagation of noise in the low- to mid-frequency range in the vicinity of the wheelhouse panel 4 into the vehicle cabin can be reduced. Note that details of the effect of reducing the propagation of noise in the low- to mid-frequency range in the vicinity of wheelhouse panel 4 into the vehicle cabin are mentioned later.

The distance-based attenuation section 112C, which is concave in a direction away from the inner panel 3, extends the propagation path of the panel-radiated sound rising between the distance-based attenuation section 112C and the inner panel 3 and achieves a distance-based attenuation effect with respect to the panel-radiated sound having been transmitted through the wheelhouse panel 4.

The second sound insulating section 112D, which is molded to have relatively small thickness, has lower air permeability, and additionally the second sound insulating section 112D, which blocks the space between the lower portion 111L of the interior-side front surface layer 111 and the wheelhouse panel 4, achieves a sound insulating effect with respect to the panel-radiated sound rising between the wheelhouse panel 4 and the lower portion 111L of the interior-side front surface layer 111.

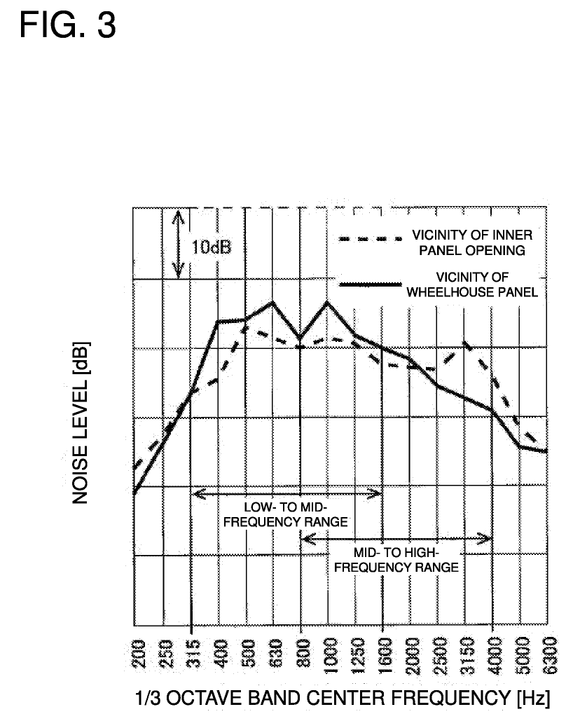

Hereinbelow, tests for checking the performance of the luggage side trim 110 according to the present embodiment and the results thereof are explained with reference to FIG. 3 to FIG. 7. FIG. 3 is a graph representing the relationship between the noise levels in the vicinity of the opening 31 of the inner panel 3 and the vicinity of a wheelhouse panel 4 and 1/3 octave band center frequency.

As illustrated in the graph in FIG. 3, 1/3 octave band analysis was conducted on noise in the vicinity of the opening 31 of the inner panel 3 and the vicinity of the wheelhouse panel 4. As a result, it was confirmed that the noise level of the mid- to high-frequency range (800 to 4000 Hz) is high in the vicinity of the opening 31 of the inner panel 3, and the noise level of the low- to mid-frequency range (315 to 1600 Hz) is high in the vicinity of the wheelhouse panel 4.

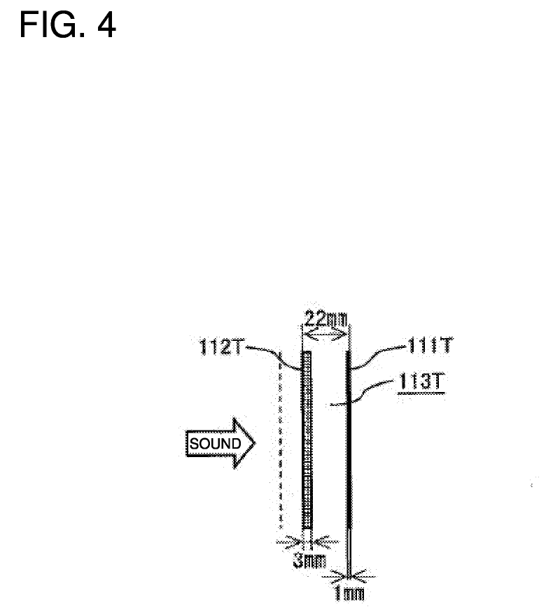

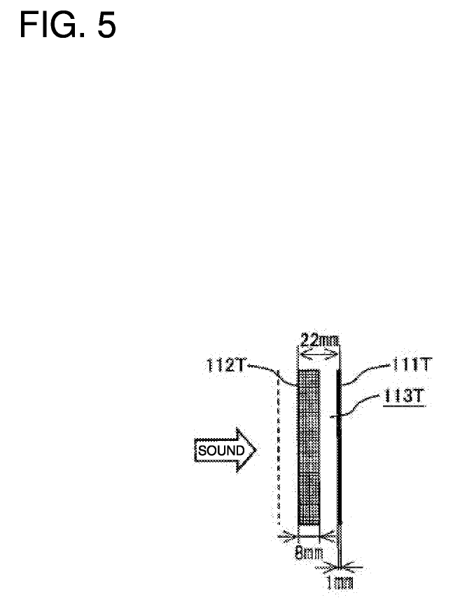

FIG. 4 is a cross-sectional view illustrating an overview of a first specimen for checking the performance of the luggage side trim 110, and FIG. 5 is a cross-sectional view illustrating an overview of a second specimen for checking the performance of the luggage side trim 110. The first specimen illustrated in FIG. 4 includes: an interior-side front surface layer 111T with a thickness of 1mm; a panel-side back surface layer 112T with a thickness of 3mm; and an intermediate air layer 113T with a thickness of 18mm. In addition, the second specimen illustrated in FIG. 5 includes: an interior-side front surface layer 111T with a thickness of 1mm; a panel-side back surface layer 112T with a thickness of 8mm; and an intermediate air layer 113T with a thickness of 13mm. The interior-side front surface layer 111T of both test specimens is made of resin, and the panel-side back surface layer 112T of both test specimens is made of felt. In addition, the thickness of both test specimens is 22mm.

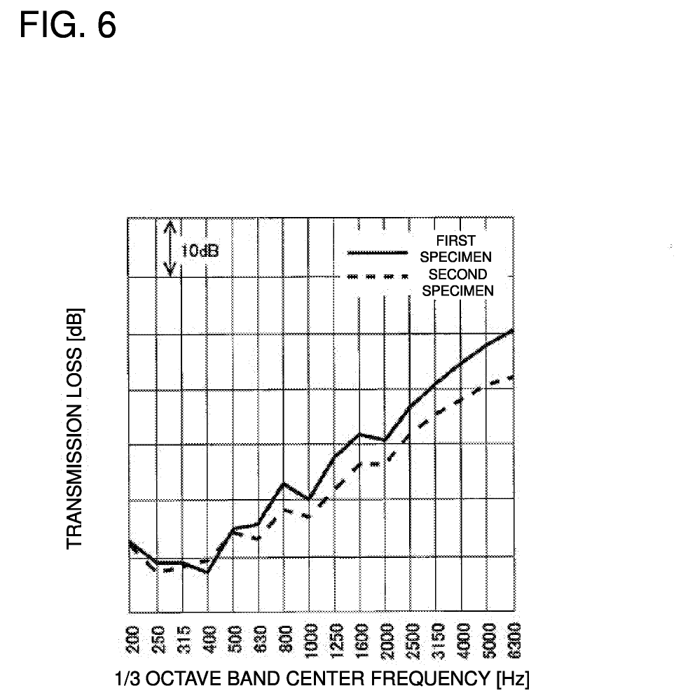

The first specimen illustrated in FIG. 4 and the second specimen illustrated in FIG. 5 were disposed in the vicinity of the wheelhouse panel 4, and 1/3 octave analysis was conducted on noise in the vicinity of the opening 31 of the inner panel 3. FIG. 6 is a graph representing the relationship between the transmission loss in the vicinity of the wheelhouse panel 4 in cases where the first specimen and the second specimen are disposed in the vicinity of the opening 31 of the inner panel 3 and 1/3 octave band center frequency.

As illustrated in the graph in FIG. 6, it was confirmed that, in a case where the first specimen having the panel-side back surface layer 112T with a thickness of 3mm is disposed in the vicinity of the wheelhouse panel 4, a high sound insulating effect with respect to noise in a wide range of frequency from the low-frequency range to the high-frequency range is achieved compared to a case where the second specimen having the panel-side back surface layer 112T with a thickness of 8mm is disposed similarly. Here, as illustrated in FIG. 3, since the noise level of the low- to mid-frequency range is high in the vicinity of the wheelhouse panel 4, a high sound insulating effect is achieved by disposing the first specimen in the vicinity of the wheelhouse panel 4.

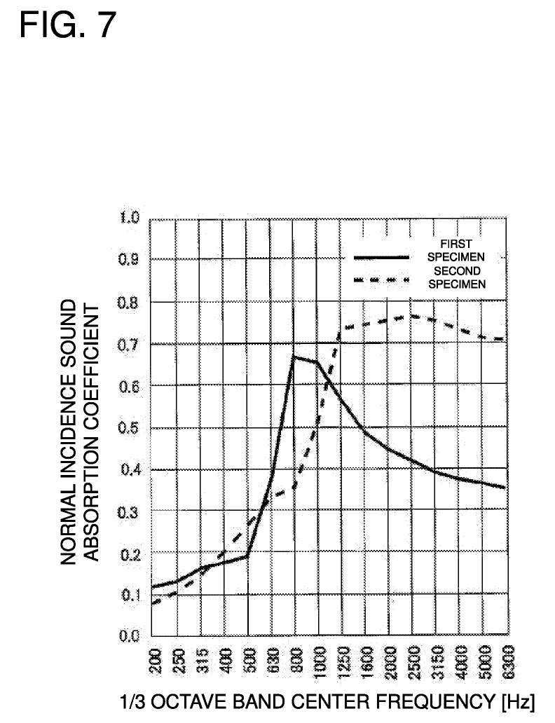

On the other hand, the first specimen illustrated in FIG. 4 and the second specimen illustrated in FIG. 5 were disposed in the vicinity of the opening 31 of the inner panel 3, and 1/3 octave analysis was conducted on noise in the vicinity of the opening 31 of the inner panel 3. FIG. 7 is a graph representing the relationship between the normal incidence sound absorption coefficient in cases where the first specimen and the second specimen are disposed in the vicinity of the opening 31 of the inner panel 3 and 1/3 octave band center frequency.

As illustrated in the graph in FIG. 7, it was confirmed that, in a case where the second specimen having the panel-side back surface layer 112T with a thickness of 8mm is disposed in the vicinity of the opening 31 of the inner panel 3, a high sound absorption effect with respect to noise in the mid- to high-frequency range is achieved compared to a case where the first specimen having the panel-side back surface layer 112T with a thickness of 3mm is disposed similarly. In addition, it was confirmed that, since the intermediate air layer 113T with a thickness of 18mm functions as a rear air layer of the first specimen having the panel-side back surface layer 112T with a thickness of 3mm, peak-type sound absorption performance is achieved. Here, as illustrated in FIG. 3, since the noise level of the mid- to high-frequency range is high in the vicinity of the opening 31 of the inner panel 3, a high sound absorption effect is achieved by disposing the second specimen in the vicinity of the opening 31 of the inner panel 3.

As explained above, the luggage side trim 100 according to the present embodiment includes: the interior-side front surface layer 111 included in the interior-side surface; the panel-side back surface layer 112 that is included in the surface on the side of the inner panel 3 and has an edge that is fixed to the interior-side front surface layer 111; and the intermediate air layer 113 that is interposed between the interior-side front surface layer 111 and the panel-side back surface layer 112. Here, the panel-side back surface layer 112 is a molded article including a layer of an air-permeable base material, and the air permeability, thickness, and area density of the panel-side back surface layer 112 can be partially adjusted at the time of the molding. Accordingly, by adjusting the air permeability, thickness, and area density of each section of the panel-side back surface layer 112 in accordance with the frequency spectrum of the panel-radiated sound radiated from each part of the surrounding panel of the luggage compartment 2, it is possible to sufficiently achieve sound absorption and sound insulation effects with respect to the panel-radiated sound around the luggage compartment 2 and effectively reduce the propagate of the panel-radiated sound having been transmitted through the wheelhouse panel 4 into the vehicle cabin. In addition, since, without installing an insulator physically separate from the panel-side back surface layer 112, it is possible to achieve sound absorption and sound insulation effects similar to those in a case where the insulator is installed, cost reduction and weight reduction are possible.

In addition, in the luggage side trim 100 according to the present embodiment, the panel-side back surface layer 112 includes: the sound absorbing section 112A which is a thick-wall section where the air-permeable base material is partially thickened; and the first sound insulating section 112B which is a thin-wall section where the air-permeable base material is partially thinned. Since the sound absorbing section 112A has relatively high air permeability and relatively low area density due to thick-wall molding, and the intermediate air layer 113 functions as a rear air layer, an excellent sound absorption effect with respect to noise in the mid- to high-frequency range is achieved. On the other hand, the first sound insulating section 112B has relatively low air permeability and relatively high area density due to thin-wall molding and provides an excellent sound insulating effect with respect to noise in the low- to mid-frequency range. In addition, the intermediate air layer 113 functions as a rear air layer of the air-permeable first sound insulating section 112B, thereby achieving peak-type sound absorption performance. Accordingly, by disposing the sound absorbing section 112A in the vicinity of a region where the frequency of the panel-radiated sound is in the mid- to high-frequency range, and disposing the first sound insulating section 112B in the vicinity of a region where the frequency of the panel-radiated sound is in the low- to mid-frequency range, it is possible to effectively reduce the propagation of the panel-radiated sound into the vehicle cabin.

In addition, in the luggage side trim 100 according to the present embodiment, the sound absorbing section 112A is disposed facing the opening 31 of the inner panel 3, and the first sound insulating section 112B is disposed facing the wheelhouse panel 4. Here, since the panel-radiated sound in the mid- to high-frequency range is generated in the vicinity of the opening 31 of the inner panel 3, and the panel-radiated sound in the low- to mid-frequency range is generated in the vicinity of the wheelhouse panel 4, it is possible to effectively reduce the propagation of the panel-radiated sound into the vehicle cabin.

In addition, in the luggage side trim 100 according to the present embodiment, since the sound absorbing section 112A and the distance-based attenuation section 112C are included in the duct together with the inner panel 3, the panel-radiated sound propagated through the duct can be attenuated at the sound absorbing wall. In addition, the distance-based attenuation section 112C is an uneven section provided at the boundary between the sound absorbing section 112A and the first sound insulating section 112B and is concave in a direction away from the inner panel 3. Accordingly, the propagation path of the panel-radiated sound propagated between the distance-based attenuation section 112C and the inner panel 3 can be extended, and the attenuation effect with respect to the panel-radiated sound can be enhanced.

Furthermore, in the luggage side trim 100 according to the present embodiment, the luggage side trim 110 has a triple-layer structure including: the panel-side back surface layer 112 including a layer of an air-permeable base material; the intermediate air layer 113 as a rear air layer; and the interior-side front surface layer 111 which is a molded article including a layer of an air-impermeable base material. Because of this, it is possible to effectively enhance the sound absorption effect and the sound insulating effect with respect to the panel-radiated sound transmitted through the luggage side trim 110.

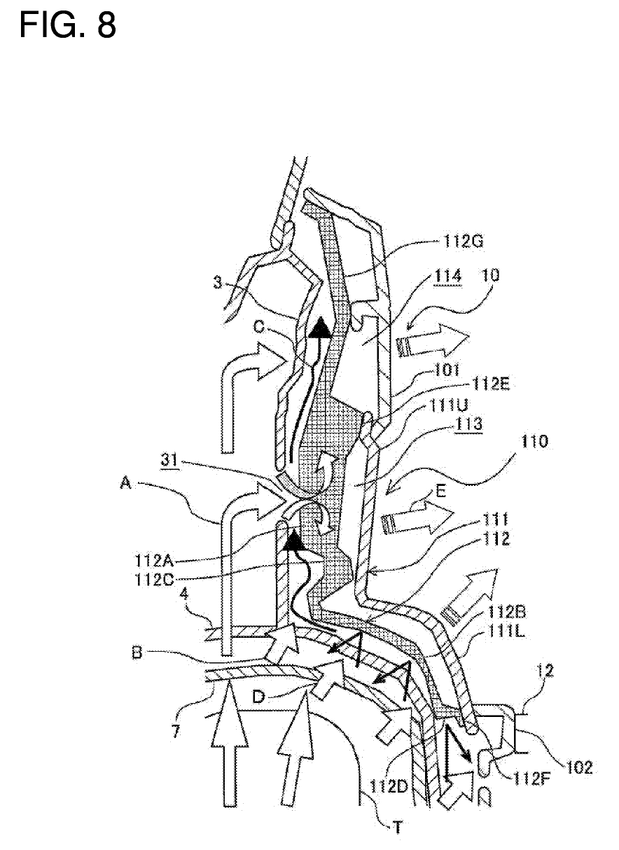

FIG. 8 is a cross-sectional view illustrating a modification example of the panel-side back surface layer 112. Note that constituent elements similar to those in the embodiment mentioned above are given identical reference signs, and the explanation of the embodiment mentioned above is referenced for the explanation of the similar constituent elements.

The modification example of the panel-side back surface layer 112 illustrated in FIG. 8 includes the sound absorbing section 112A, the first sound insulating section 112B, the distance-based attenuation section 112C, the second sound insulating section 112D, the fixing sections 112E and 112F, and an extended section 112G. The extended section 112G extends upward from the upper end of the sound absorbing section 112A. The upper end of the extended section 112G is fixed to the upper end of the back surface of the upper luggage side trim 101. Note that examples of the fixation method include pasting using an adhesive, welding by melting the base materials using heat or vibration, and the like. It is sufficient if fixation by adhesion, welding, or the like is performed over the entire circumference or partially, and, in a case where fixation by adhesion, welding, or the like is performed partially, the remaining portion may be fixed by engagement using claws.

The extended section 112G, which is molded to have relatively small thickness, has lower air permeability and achieves a sound insulating effect and a sound absorption effect that are mentioned later with respect to the panel-radiated sound having been transmitted through the inner panel 3 in the vicinity of the inner panel 3. Due to the sound insulating effect achieved with the double-wall structure including the extended section 112G and the luggage side trim 101 with an intermediate air layer 114 as a rear air layer being interposed therebetween and the sound absorption effect achieved with the intermediate air layer 113, which functions as a rear air layer of the extended section 112G, sound transmitted through the luggage side trim 101 and propagated into the vehicle cabin is attenuated. Thereby, the propagation of noise in the vicinity of the inner panel 3 into the vehicle cabin can be reduced.

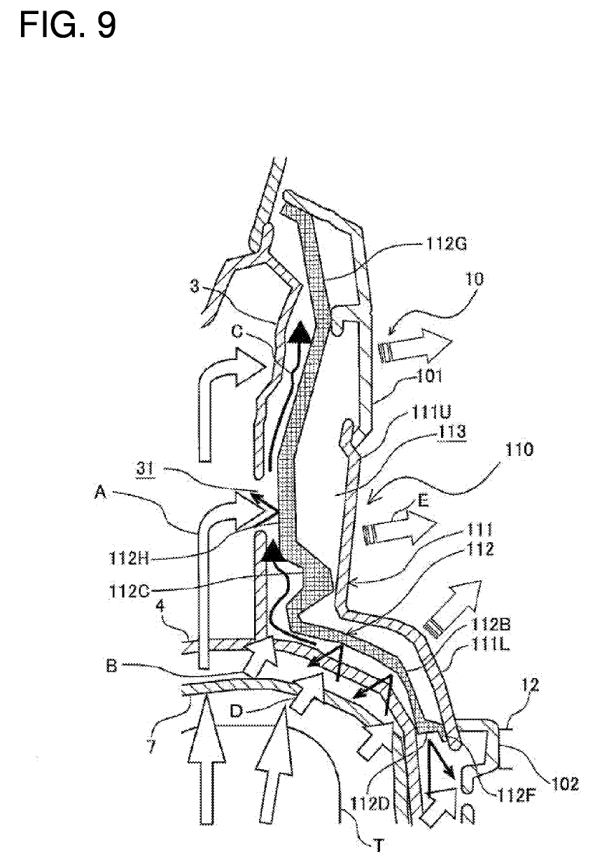

FIG. 9 is a cross-sectional view illustrating another modification example of the panel-side back surface layer 112. Note that constituent elements similar to those in the embodiment and modification example mentioned above are given identical reference signs, and the explanation of the embodiment and modification example mentioned above is referenced for the explanation of the similar constituent elements.

The modification example of the panel-side back surface layer 112 illustrated in FIG. 9 includes a third sound insulating section 112H instead of the sound absorbing section 112A of the modification example mentioned above. The third sound insulating section 112H, which is molded to have relatively small thickness, has lower air permeability and achieves a sound insulating effect with respect to the panel-radiated sound having entered the space between the inner panel 3 and the luggage side trim 110 through the opening 31 in the vicinity of the opening 31 of the inner panel 3. In addition, due to the sound insulating effect achieved with the double-wall structure including: the third sound insulating section 112H and the extended section 112G; and the upper portion 111U of the interior-side front surface layer 111 and the upper luggage side trim 101 with the intermediate air layer 113 as a rear air layer being interposed therebetween and the sound absorption effect achieved with the intermediate air layer 113, which functions as a rear air layer of the third sound insulating section 112H and the extended section 112G, sound transmitted through the luggage side trims 110 and 101 and propagated into the vehicle cabin is attenuated. Thereby, the propagation of noise in the vicinity of the inner panel 3 into the vehicle cabin can be reduced.

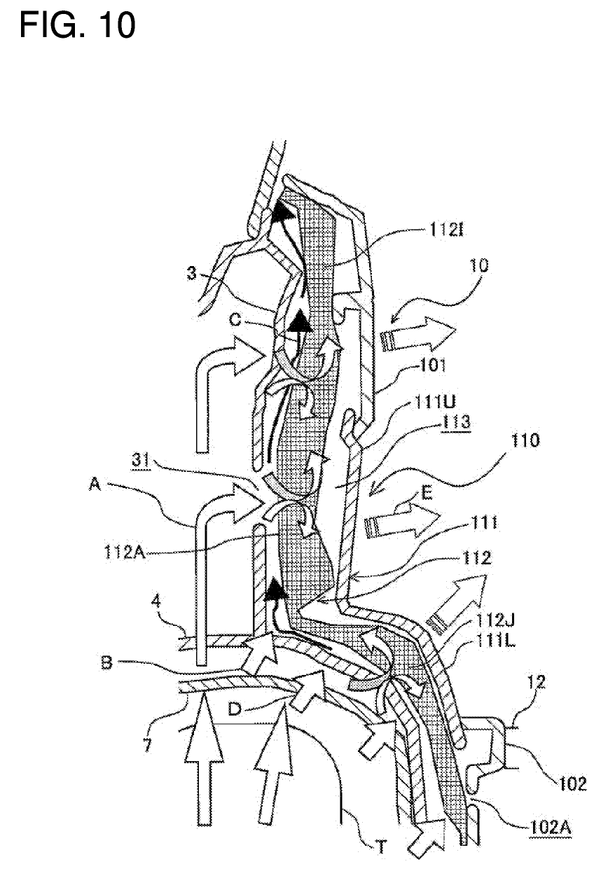

FIG. 10 is a cross-sectional view illustrating another modification example of the panel-side back surface layer 112. Note that constituent elements similar to those in the embodiment and modification examples mentioned above are given identical reference signs, and the explanation of the embodiment and modification examples mentioned above is referenced for the explanation of the similar constituent elements.

The modification example of the panel-side back surface layer 112 illustrated in FIG. 10 includes a second sound absorbing section 112I instead of the extended section 112G of the modification example mentioned above and illustrated in FIG. 8. In addition, the modification example of the panel-side back surface layer 112 illustrated in FIG. 10 includes a third sound absorbing section 112J instead of the first sound insulating section 112B of the modification example mentioned above and illustrated in FIG. 8.

The second sound absorbing section 112I extends upward from the upper end of the sound absorbing section 112A. The upper end of the second sound absorbing section 112I is fixed to the upper end of the back surface of the upper luggage side trim 101. Note that examples of the fixation method include pasting using an adhesive, welding by melting the base materials using heat or vibration, and the like. It is sufficient if fixation by adhesion, welding, or the like is performed over the entire circumference or partially, and, in a case where fixation by adhesion, welding, or the like is performed partially, the remaining portion may be fixed by engagement using claws. The sound absorbing section 112A and the second sound absorbing section 112I, which are molded continuously to have relatively large thickness, can provide an enhanced sound absorption effect as a porous body. In addition, the second sound absorbing section 112I achieves a sound absorption effect with respect to the panel-radiated sound having been transmitted through the inner panel 3 and the panel-radiated sound rising between the second sound absorbing section 112I and the inner panel 3. In addition, due to the sound insulating effect achieved with the double-wall structure including: the sound absorbing section 112A and the second sound absorbing section 112I; and the upper portion 111U of the interior-side front surface layer 111 and the upper luggage side trim 101 with the intermediate air layer 113 as a rear air layer being interposed therebetween and the sound absorption effect achieved with the intermediate air layer 113, which functions as a rear air layer of the sound absorbing section 112A and the second sound absorbing section 112I, sound transmitted through the luggage side trims 110 and 101 and propagated into the vehicle cabin is attenuated. Thereby, the propagation of noise in the vicinity of the inner panel 3 into the vehicle cabin can be reduced.

In addition, the third sound absorbing section 112J extends downward from the lower end of the sound absorbing section 112A. The lower end of the third sound absorbing section 112J is fixed to the side wall of the luggage-side-trim bottom 102. Note that examples of the fixation method include pasting using an adhesive, welding by melting the base materials using heat or vibration, and the like. It is sufficient if fixation by adhesion, welding, or the like is performed over the entire circumference or partially, and, in a case where fixation by adhesion, welding, or the like is performed partially, the remaining portion may be fixed by engagement using claws. Here, an opening 102A such as a wire insertion hole or a ventilation hole is formed through the side wall of the luggage-side-trim bottom 102, and the third sound absorbing section 112J is fixed to the side wall of the luggage-side-trim bottom 102 so as to cover the opening 102A.

The third sound absorbing section 112J, which is molded to have relatively large thickness, can provide an enhanced sound absorption effect as a porous body. The third sound absorbing section 112J achieves a sound absorption effect with respect to the panel-radiated sound having been transmitted through the wheelhouse panel 4. In addition, due to the sound insulating effect achieved with the double-wall structure including the lower portion 111L of the interior-side front surface layer 111 and the sound absorption effect achieved with the intermediate air layer 113, which functions as a rear air layer of the sound absorbing section 112A and the second sound absorbing section 112I, sound transmitted through the luggage side trim 110 and propagated into the vehicle cabin is attenuated. Thereby, the propagation of noise in the vicinity of the wheelhouse panel 4 into the vehicle cabin can be reduced.

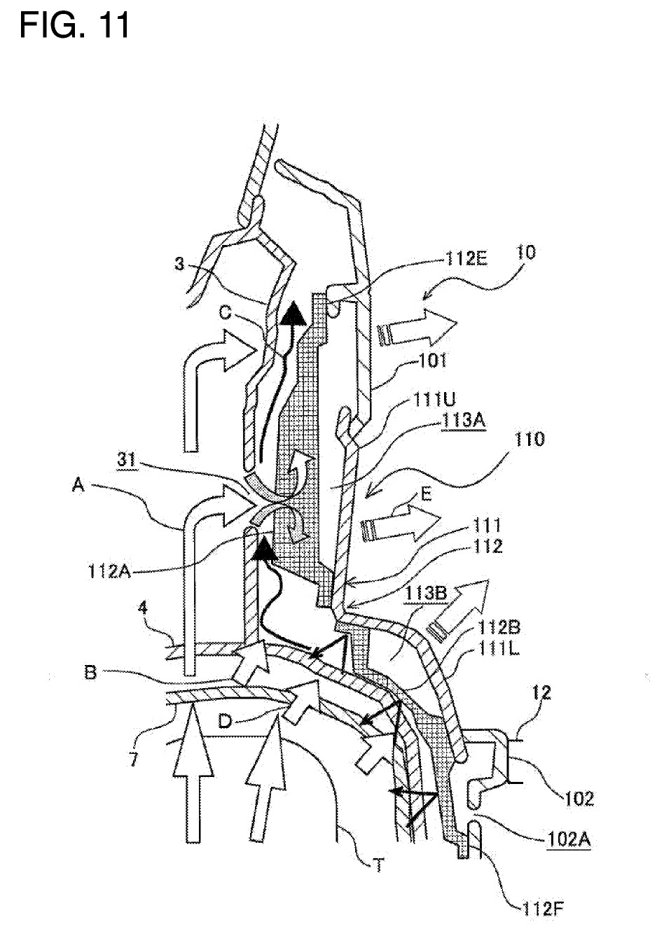

FIG. 11 is a cross-sectional view illustrating another modification example of the panel-side back surface layer 112. Note that constituent elements similar to those in the embodiment and modification examples mentioned above are given identical reference signs, and the explanation of the embodiment and modification examples mentioned above is referenced for the explanation of the similar constituent elements.

The modification example of the panel-side back surface layer 112 illustrated in FIG. 11 has configuration in which the sound absorbing section 112A and the first sound insulating section 112B of the embodiment mentioned above and illustrated in FIG. 2 are divided. The lower end of the sound absorbing section 112A is fixed to the lower end of the upper portion 111U of the interior-side front surface layer 111. In addition, the upper end of the first sound insulating section 112B is fixed to the upper end of the lower portion 111L of the interior-side front surface layer 111. Furthermore, the lower end of the first sound insulating section 112B is fixed to the side wall of the luggage-side-trim bottom 102. Note that the second sound insulating section 112D of the embodiment mentioned above and illustrated in FIG. 2 is not present, and the lower end of the first sound insulating section 112B is fixed to the side wall of the luggage-side-trim bottom 102 so as to cover the opening 102A. Note that examples of the fixation method include pasting using an adhesive, welding by melting the base materials using heat or vibration, and the like. It is sufficient if fixation by adhesion, welding, or the like is performed over the entire circumference or partially, and, in a case where fixation by adhesion, welding, or the like is performed partially, the remaining portion may be fixed by engagement using claws.

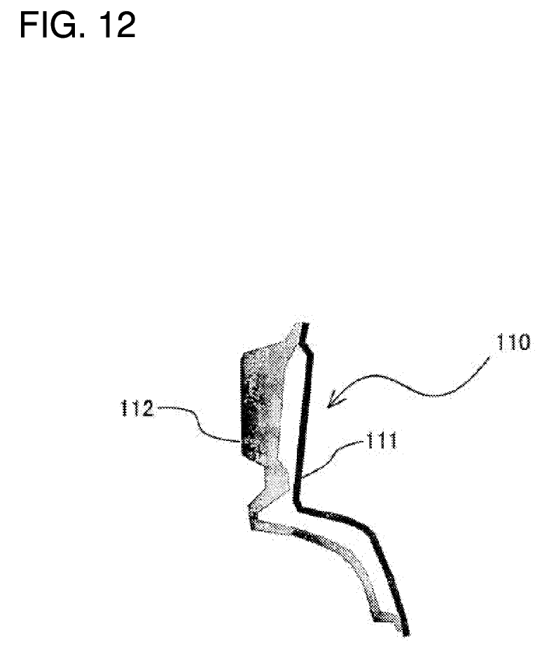

FIG. 12 is a cross-sectional view illustrating another modification example of the panel-side back surface layer 112. Note that constituent elements similar to those in the embodiment and modification examples mentioned above are given identical reference signs, and the explanation of the embodiment and modification examples mentioned above is referenced for the explanation of the similar constituent elements.

In the modification example of the panel-side back surface layer 112 illustrated in FIG. 12, the air permeability differs between the panel side and the interior side of the air-permeable base material included in the panel-side back surface layer 112 due to a difference in area density between the panel side and the interior side. For example, by making the amount of heating on one of the panel side and the interior side greater than the amount of heating on the other at the time of molding of the air-permeable base material, the area density of the one side is made relatively higher, and the area density of the other side is made relatively lower.

In a case where the panel-side area density is made higher than the interior-side area density in the panel-side back surface layer 112 of the present modification example, sound insulation/sound absorption effects with respect to noise in the low- to mid-frequency range is enhanced. On the other hand, in a case where the interior-side area density is made higher than the panel-side area density in the panel-side back surface layer 112 of the present modification example, the sound absorption effect with respect to noise in the mid- to high-frequency range is enhanced.

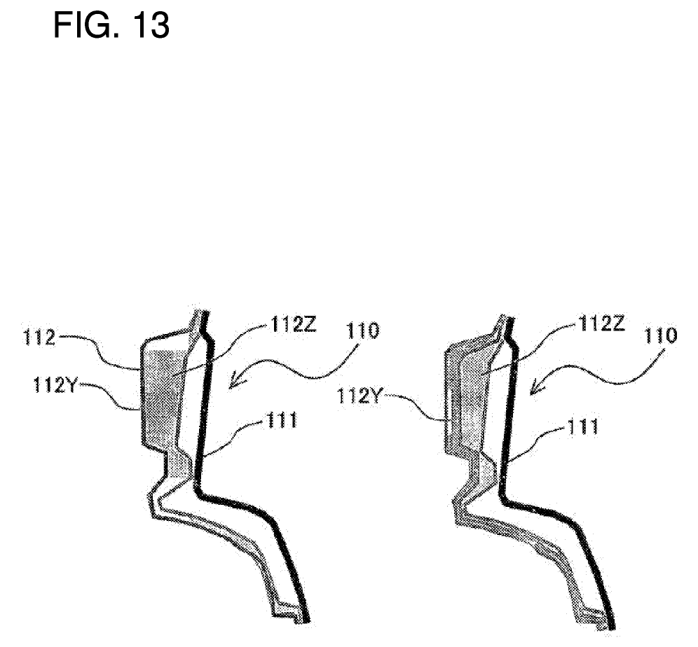

FIG. 13 is a cross-sectional view illustrating another modification example of the panel-side back surface layer 112. Note that constituent elements similar to those in the embodiment and modification examples mentioned above are given identical reference signs, and the explanation of the embodiment and modification examples mentioned above is referenced for the explanation of the similar constituent elements.

The modification example of the panel-side back surface layer 112 illustrated in FIG. 13 has a double-layer structure including a base material layer 112Z and a skin layer 112Y. The skin layer 112Y covers the panel-side front surface of the base material layer 112Z. Note that the skin layer 112Y may be provided over the entire panel-side front surface of the base material layer 112Z or may be provided over a part (e.g. at a rate of 30 to 99%) of the panel-side front surface of the base material layer 112Z. Furthermore, the skin layer 112Y may have small thickness as illustrated on the left side in FIG. 13 or may have large thickness as illustrated on the right side in FIG. 13.

Examples of the skin layer 112Y include a resin film, a low-air-permeability non-woven fabric, a sound insulating sheet, urethane, and the like. Examples of the material of the resin film include polypropylene (PP), polyethylene (PE), polyethylene terephthalate (PET), and the like. Examples of the density of the resin film include 10 to 500 g/m². Examples of the material of the low-air-permeability non-woven fabric include PP, PET, and the like. Examples of the density of the low-air-permeability non-woven fabric include 30 to 500 g/m². Examples of the material of the sound insulating sheet include rubber, ethylene propylene diene rubber (EPDM), PP, and the like. Examples of the density of the sound insulating sheet include 500 to 6000 g/m². Examples of the structure of urethane include a closed-cell structure, a semi-closed-cell structure, and the like. Examples of the density of urethane include 20 to 500 g/m².

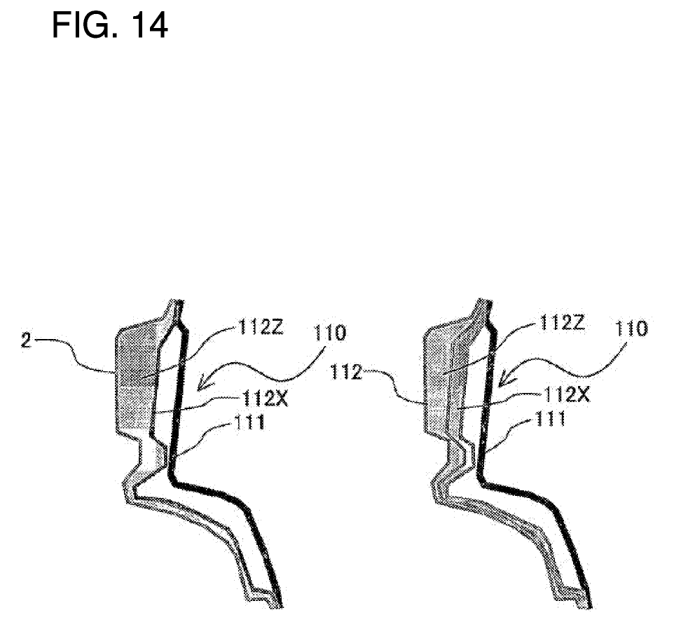

FIG. 14 is a cross-sectional view illustrating another modification example of the panel-side back surface layer 112. Note that constituent elements similar to those in the embodiment and modification examples mentioned above are given identical reference signs, and the explanation of the embodiment and modification examples mentioned above is referenced for the explanation of the similar constituent elements.

The modification example of the panel-side back surface layer 112 illustrated in FIG. 14 has a double-layer structure including the base material layer 112Z and a back surface layer 112X. The back surface layer 112X covers the interior-side front surface of the base material layer 112Z. Note that the back surface layer 112X may be provided over the entire interior-side front surface of the base material layer 112Z or may be provided over a part (e.g. at a rate of 30 to 99%) of the panel-side front surface of the base material layer 112Z. Furthermore, the back surface layer 112X may have small thickness as illustrated on the left side in FIG. 14 or may have large thickness as illustrated on the right side in FIG. 14.

Examples of the back surface layer 112X include a resin film, a low-air-permeability non-woven fabric, a sound insulating sheet, urethane, and the like. Examples of the material of the resin film include PP, PE, PET, and the like. Examples of the density of the resin film include 10 to 500 g/m². Examples of the material of the low-air-permeability non-woven fabric include PP, PET, and the like. Examples of the density of the low-air-permeability non-woven fabric include 30 to 500 g/m². Examples of the material of the sound insulating sheet include rubber, EPDM, PP, and the like. Examples of the density of the sound insulating sheet include 500 to 6000 g/m². Examples of the structure of urethane include a closed-cell structure, a semi-closed-cell structure, and the like. Examples of the density of urethane include 20 to 500 g/m².

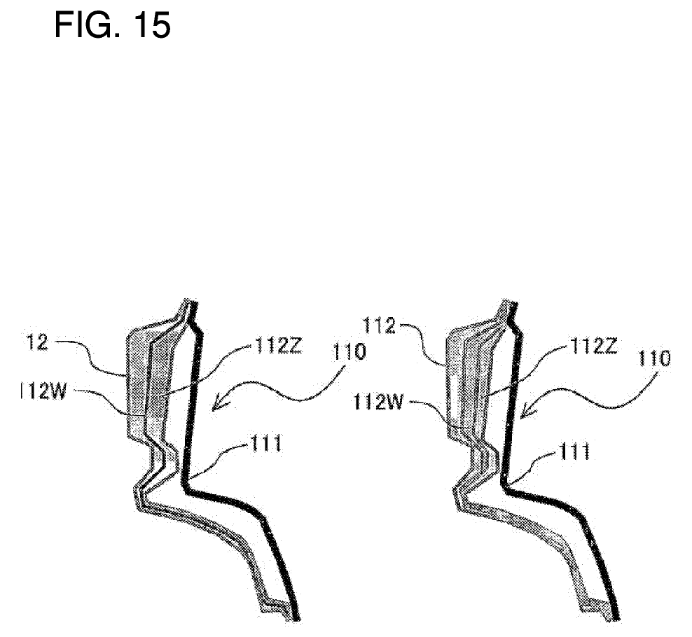

FIG. 15 is a cross-sectional view illustrating another modification example of the panel-side back surface layer 112. Note that constituent elements similar to those in the embodiment and modification examples mentioned above are given identical reference signs, and the explanation of the embodiment and modification examples mentioned above is referenced for the explanation of the similar constituent elements.

The modification example of the panel-side back surface layer 112 illustrated in FIG. 15 has a triple-layer structure including an intermediate layer 112W and the base material layer 112Z divided into two sections by the intermediate layer 112W. The intermediate layer 112W is buried in the base material layer 112Z so as to divide the base material layer 112Z into two sections in the thickness direction. Note that the intermediate layer 112W may be provided over the entire base material layer 112Z or may be provided at a part (e.g. at a rate of 30 to 99%) in the base material layer 112Z. Furthermore, the intermediate layer 112W may have small thickness as illustrated on the left side in FIG. 15 or may have large thickness as illustrated on the right side in FIG. 15.

Examples of the intermediate layer 112W include a resin film, a low-air-permeability non-woven fabric, a sound insulating sheet, urethane, and the like. Examples of the material of the resin film include PP, PE, PET, and the like. Examples of the density of the resin film include 10 to 500 g/m². Examples of the material of the low-air-permeability non-woven fabric include PP, PET, and the like. Examples of the density of the low-air-permeability non-woven fabric include 30 to 500 g/m². Examples of the material of the sound insulating sheet include rubber, EPDM, PP, and the like. Examples of the density of the sound insulating sheet include 500 to 6000 g/m². Examples of the structure of urethane include a closed-cell structure, a semi-closed-cell structure, and the like. Examples of the density of urethane include 20 to 500 g/m².

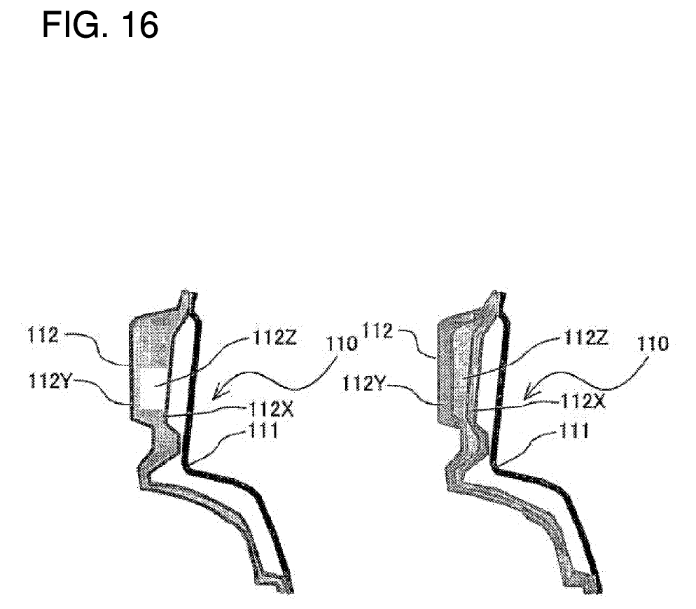

FIG. 16 is a cross-sectional view illustrating another modification example of the panel-side back surface layer 112. Note that constituent elements similar to those in the embodiment and modification examples mentioned above are given identical reference signs, and the explanation of the embodiment and modification examples mentioned above is referenced for the explanation of the similar constituent elements.

The modification example of the panel-side back surface layer 112 illustrated in FIG. 16 has a triple-layer structure including the base material layer 112Z, the skin layer 112Y, and the back surface layer 112X. The skin layer 112Y covers the panel-side front surface of the base material layer 112Z. In addition, the back surface layer 112X covers the interior-side front surface of the base material layer 112Z. Note that the skin layer 112Y may be provided over the entire panel-side front surface of the base material layer 112Z or may be provided over a part (e.g. at a rate of 30 to 99%) of the panel-side front surface of the base material layer 112Z. In addition, the back surface layer 112X may be provided over the entire interior-side front surface of the base material layer 112Z or may be provided over a part (e.g. at a rate of 30 to 99%) of the panel-side front surface of the base material layer 112Z. Furthermore, the skin layer 112Y and the back surface layer 112X may have small thickness as illustrated on the left side in FIG. 16 or may have large thickness as illustrated on the right side in FIG. 16.

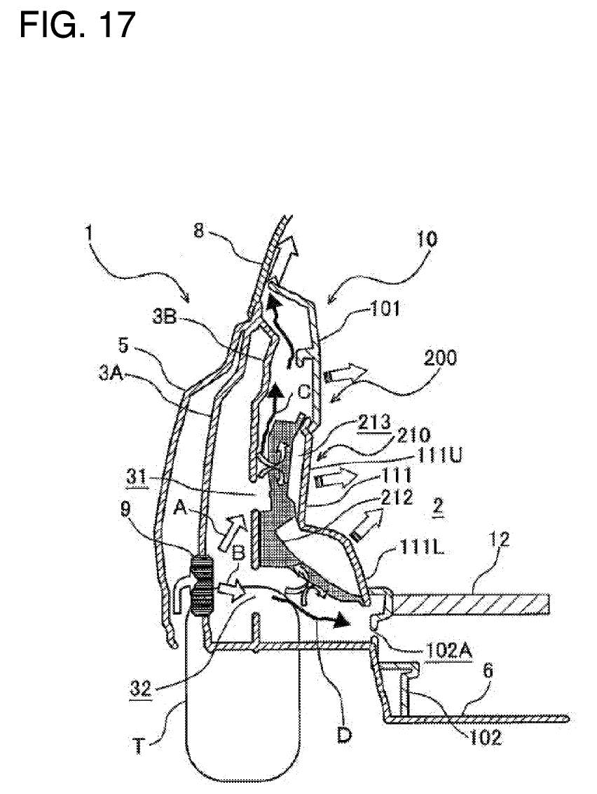

FIG. 17 is a cross-sectional view illustrating a luggage side trim 200 and the body structure of the vehicle 1 according to another embodiment according to the present invention as seen from the rear side of the vehicle. Note that constituent elements similar to those in the embodiment mentioned above are given identical reference signs, and the explanation of the embodiment mentioned above is referenced for the explanation of the similar constituent elements.

As illustrated in FIG. 17, the luggage side trim 200 is disposed in the luggage compartment 2 so as to cover an inner panel 3B included in the side wall of the luggage compartment 2. The luggage side trim 200 includes the upper luggage side trim 101, a lower luggage side trim 210, and the luggage-side-trim bottom 102. The lower end of the upper luggage side trim 101 and the upper end of the lower luggage side trim 210 engage with each other, and the lower end of the lower luggage side trim 210 and the upper end of the luggage-side-trim bottom 102 engage. Thereby, the luggage side trim 200 in which the upper luggage side trim 101, the lower luggage side trim 210, and the luggage-side-trim bottom 102 are integrated is formed. The upper luggage side trim 101, the lower luggage side trim 210, and the luggage-side-trim bottom 102 may be included in the luggage side trim 200 as an integrated body structure without engagement therebetween or may be included in the luggage side trim 200 as a structure in which integrally molded ones and a physically separate one engage with each other.

The lower luggage side trim 210 is a cover member that covers the lower side of the inner panel 3B. The luggage side trim 210 has a triple-layer structure including the interior-side front surface layer 111, a panel-side back surface layer 212, and an intermediate air layer 213. The outer circumferential edge of the interior-side front surface layer 111 and the outer circumferential edge of the panel-side back surface layer 212 are fixed, and the intermediate air layer 213 is formed between the interior-side front surface layer 111 and the panel-side back surface layer 212. Note that examples of the fixation method include pasting using an adhesive, welding by melting the base materials using heat or vibration, and the like. It is sufficient if fixation by adhesion, welding, or the like is performed over the entire circumference or partially, and, in a case where fixation by adhesion, welding, or the like is performed partially, the remaining portion may be fixed by engagement using claws.

The body structure of the vehicle 1 includes inner panels 3A and 3B, the outer panel 5, the floor panel 6, the window glass 8, and a drafter 9. The inner panel 3A is disposed between the inner panel 3B and the outer panel 5. The lower section of the inner panel 3A is provided with the drafter 9. The drafter 9 is a discharge port having a rubber-made shutter.

Openings 31 and 32 such as wire insertion holes or ventilation holes are formed through the inner panel 3B. The opening 31 is positioned at the height of the upper portion 111U of the interior-side front surface layer 111, and the opening 32 is positioned at the height of the lower portion 111L of the interior-side front surface layer 111. The openings 31 and 32, which are used as wire insertion holes, ventilation holes, or the like, are not allowed to be blocked with the luggage side trim 210. Because of this, as represented by arrows A and B, sound (hereinbelow, drafter-radiated sound) having been transmitted through the drafter 9 enters the space between the inner panel 3B and the luggage side trim 200 through the openings 31 and 32. Then, as represented by an arrow C, the drafter-radiated sound having entered the space between the inner panel 3B and the luggage side trim 200 through the opening 31 is propagated between the inner panel 3B and the luggage side trim 200, and enters the vehicle cabin through the gap between the upper luggage side trim 101 and the window glass 8 or a pillar connected to the ceiling.

In addition, as represented by an arrow D, the drafter-radiated sound having entered the space between the inner panel 3B and the luggage side trim 200 through the opening 32 is propagated between the inner panel 3B and the luggage side trim 200 and enters the vehicle cabin through a gap of the luggage-side-trim bottom 102 or the opening 102A.

In view of this, in the present embodiment, the lower luggage side trim 210 that achieves effects such as sound absorption, sound insulation, and attenuation with respect to the sound propagated between the inner panel 3B and the luggage side trim 200 and the sound transmitted through the luggage side trim 200 is provided. Hereinbelow, the configuration and effects of the luggage side trim 210 are explained.

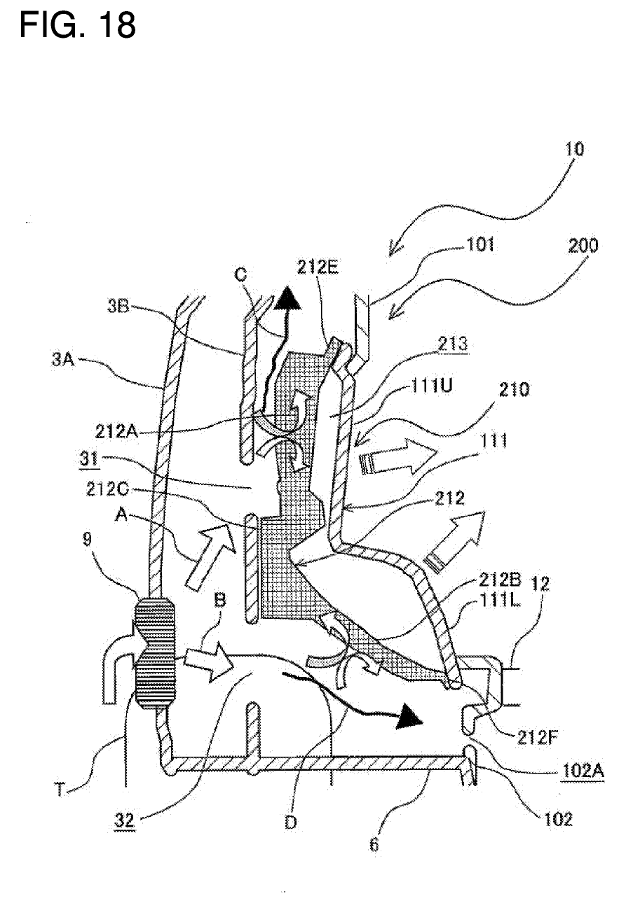

FIG. 18 is an enlarged cross-sectional view of the luggage side trim 210 illustrated in FIG. 17. The panel-side back surface layer 212 of the luggage side trim 210 illustrated in the drawing is a molded article formed using one or more layers of an air-permeable base material (porous body). Examples of the air-permeable base material include a molded non-woven fabric, a felt, glass wool, urethane, and the like. In addition, the molding method for the air-permeable base material include cold pressing, hot pressing, and the like.

The air permeability of the panel-side back surface layer 212 is preferably 1 to 60 cm³/cm²⋅SEC and is more preferably 5 to 30 cm³/cm²⋅SEC. In addition, the thickness of the panel-side back surface layer 212 is preferably 2 to 100 mm and is more preferably 3 to 25 mm. In addition, the area density of the panel-side back surface layer 212 is preferably 200 to 2500 g/m² and is more preferably 600 to 1400 g/m². Note that the front surface or back surface of the panel-side back surface layer 212 may be provided with a non-woven fabric, a film, a sheet, or the like.

The thickness of the intermediate air layer 213 of the luggage side trim 210 is preferably 0.1 to 200 mm and is more preferably 3 to 30mm. In addition, examples of the fixation method for the interior-side front surface layer 111 and the panel-side back surface layer 212 include hot melt bonding, adhesion using an adhesive, ultrasonic welding, fixation by anchor effect, and the like.

The panel-side back surface layer 212 includes a sound absorbing section 212A, a sound insulating/sound absorbing section 212B, an intermediate section 212C, and fixing sections 212E and 212F. The sound absorbing section 212A is interposed between the upper portion 111U of the interior-side front surface layer 111 and the inner panel 3B. The opening 31 of the inner panel 3B faces the sound absorbing section 212A. The fixing section 212E fixes the outer circumferential edge of the sound absorbing section 212A and the outer circumferential edge of the upper portion 111U of the interior-side front surface layer 111. Note that it is sufficient if the fixation by the fixing section 212E is performed over the entire circumference or partially.

The sound insulating/sound absorbing section 212B is positioned in the space surrounded by the lower portion 111L of the interior-side front surface layer 111, the floor panel 6, and the lower section of the inner panel 3B. The fixing section 212F fixes the outer circumferential edge of the sound insulating/sound absorbing section 212B and the outer circumferential edge of the lower portion 111L of the interior-side front surface layer 111. Note that it is sufficient if the fixation by the fixing section 212F is performed over the entire circumference or partially.

The intermediate section 212C is provided at the boundary between the sound absorbing section 212A and the sound insulating/sound absorbing section 212B. The intermediate section 212C abuts on a portion between the opening 31 and the opening 32 of the inner panel 3B. Because of this, a propagation path of the drafter-radiated sound extending from the opening 31 to the window glass 8 is formed above the intermediate section 212C, and a propagation path of the drafter-radiated sound extending from the opening 32 to the opening 102A is formed below the intermediate section 212C. In addition, although not illustrated, by providing an extending section protruding from the upper section of the intermediate section 212C to a position facing a drafter 7 through the opening 31 and providing an extending section protruding from the lower section of the intermediate section 212C through the opening 32 to a position facing the drafter 7, the propagation paths can be extended.

Here, the air permeability, thickness, and area density of each section of the panel-side back surface layer 212 differ. The sound absorbing section 212A, which is molded to have relatively large thickness in the range of, for example, 15 to 50mm, achieves relatively high air permeability and relatively low area density. In contrast, the sound insulating/sound absorbing section 212B, which is molded to have relatively small thickness in the range of, for example, 2 to 15mm, achieves relatively low air permeability and relatively high area density.

The panel-side back surface layer 212 is a molded article molded by pressurizing and heating or pressurizing an air-permeable base material (porous body), and the air permeability, thickness, and area density of each section are adjusted by partially adjusting the pressure or amount of heat at the time of the molding. The sound absorbing section 212A is molded to have relatively large thickness by relatively reducing the pressure and amount of heat at the time of the molding, and the sound insulating/sound absorbing section 212B is molded to have relatively small thickness by relatively increasing the pressure and amount of heat at the time of the molding.

The sound absorbing section 212A, which is molded to have relatively large thickness, can provide an enhanced sound absorption effect as a porous body and achieves a sound absorption effect with respect to the drafter-radiated sound that enters the space between the inner panel 3B and the luggage side trim 210 through the opening 31 in the vicinity of the opening 31 of the inner panel 3B. In addition, due to the double-wall structure including the sound absorbing section 212A and the upper portion 111U of the interior-side front surface layer 111 with the intermediate air layer 213 as a rear air layer being interposed therebetween, the sound absorption performance and the sound insulation performance are enhanced, and sound transmitted through the luggage side trim 210 and propagated into the vehicle cabin is absorbed and attenuated. Furthermore, since the sound absorbing section 212A is included in the wall section of the sound absorbing duct extending upward from the opening 31, the drafter-radiated sound propagated from the opening 31 to the window glass 8 or propagated through the pillar connected to the ceiling is absorbed and attenuated. Thereby, the propagation of noise in the vicinity of the opening 31 of the inner panel 3B into the vehicle cabin can be reduced.

The sound insulating/sound absorbing section 212B, which is molded to have relatively small thickness, has lower air permeability and achieves a sound insulating effect with respect to the drafter-radiated sound that enters the space between the inner panel 3B and the luggage side trim 210 through the opening 32 in the vicinity of the opening 32 of the inner panel 3B. Thereby, noise in the low- to mid-frequency range in the vicinity of the opening 32 of the inner panel 3B is reduced. In addition, due to the double-wall structure including the sound insulating/sound absorbing section 212B and the lower portion 111L of the interior-side front surface layer 111 with the intermediate air layer 213 as a rear air layer being interposed therebetween, sound transmitted through the sound insulating/sound absorbing section 212B and propagated into the vehicle cabin is absorbed and attenuated. Furthermore, since the sound insulating/sound absorbing section 212B is included in the wall section of the sound absorbing duct extending from the opening 32 to the inner side in the vehicle-width direction, the drafter-radiated sound propagated through the opening 32 into the opening 102A is absorbed and attenuated. Thereby, the propagation of noise in the vicinity of the opening 32 of the inner panel 3B into the vehicle cabin can be reduced.

As explained above, in the luggage side trim 200 according to the present embodiment, the panel-side back surface layer 212 includes: the sound absorbing section 212A which is a thick-wall section where the air-permeable base material is partially thickened; and the sound insulating/sound absorbing section 212B which is a thin-wall section where the air-permeable base material is partially thinned. The sound absorbing section 212A has relatively high air permeability and relatively low area density due to thick-wall molding and provides an excellent sound absorption effect with respect to noise in the mid- to high-frequency range. On the other hand, the sound insulating/sound absorbing section 212B has relatively low air permeability and relatively high area density due to thin-wall molding and provides an excellent sound insulating effect with respect to noise in the low- to mid-frequency range. In addition, the sound insulating/sound absorbing section 212B provides also an excellent sound absorption effect with respect to noise in the mid- to high-frequency range due to the double-wall structure including the intermediate air layer 213 as a rear air layer. Accordingly, by disposing the sound absorbing section 212A in the vicinity of the opening 31 where the frequency of the drafter-radiated sound is in the mid- to high-frequency range, and disposing the double-wall structure including the sound insulating/sound absorbing section 212B and the intermediate air layer 213 in the vicinity of the opening 32 where the frequency of the drafter-radiated sound is in the mid- to high-frequency range, it is possible to effectively reduce the propagation of the drafter-radiated sound through the openings 31 and 32 into the vehicle cabin. In addition, by disposing the sound insulating/sound absorbing section 212B in the vicinity of the inner panel 3B where the frequency of the drafter-radiated sound is in the low- to mid-frequency range, it is possible to effectively reduce the propagation of the drafter-radiated sound having been transmitted through the inner panel 3B into the vehicle cabin.

In addition, in the luggage side trim 200 according to the present embodiment, since the sound absorbing section 212A is included in the duct together with the inner panel 3B, the drafter-radiated sound propagated through the duct can be attenuated at the sound absorbing wall. In addition, since the sound absorbing section 212A can extend the propagation path of the drafter-radiated sound, the attenuation effect with respect to the drafter-radiated sound can be enhanced.

In addition, since the sound insulating/sound absorbing section 212B is included in the duct together with the floor panel 6, the drafter-radiated sound propagated through the duct can be attenuated at the sound absorbing wall. Furthermore, since the sound insulating/sound absorbing section 212B can extend the propagation path of the drafter-radiated sound, the attenuation effect with respect to the drafter-radiated sound can be enhanced.

Furthermore, in the luggage side trim 200 according to the present embodiment, the luggage side trim 210 has a triple-layer structure including: the panel-side back surface layer 212 including a layer of an air-permeable base material; the intermediate air layer 213; and the interior-side front surface layer 111 which is a molded article including a layer of an air-impermeable base material. Because of this, it is possible to effectively enhance the sound absorption effect and the sound insulating effect with respect to the panel-radiated sound transmitted through the luggage side trim 210.

Although the present invention has been explained thus far on the basis of the embodiments, the present invention is not limited to the embodiments mentioned above. Modifications may be made or known or well-known technologies may be combined if possible, within the scope not departing from the spirit of the present invention.

For example, whereas the interior-side front surface layer 111 includes an air-impermeable base material in the embodiments mentioned above, the interior-side front surface layer 111 may include an air-permeable base material. In addition, the target noise is not limited to the panel-radiated sound having been transmitted through the wheelhouse panel 4 or the drafter-radiated sound having been transmitted through the drafter 9, but may be panel-radiated sound transmitted through the floor panel 6 and the like.

### REFERENCE SIGNS LIST

3: Inner panel

3B: Inner panel (duct wall section)

4: Wheelhouse panel

6: Floor panel

9: Drafter

31: Opening

32: Opening

100: Luggage side trim

110: Luggage side trim

111: Interior-side front surface layer

112: Panel-side back surface layer

112A: Sound absorbing section (thick-wall section)

112B: First sound insulating section (thin-wall section, wall section)

112C: Distance-based attenuation section (uneven section, wall section)

112E: Fixing section (edge)

112F: Fixing section (edge)

113: Intermediate air layer (air layer)

114: Intermediate air layer (air layer)

200: Luggage side trim

210: Luggage side trim

212: Panel-side back surface layer

212A: Sound absorbing section (thick-wall section)

212B: Sound insulating/sound absorbing section (thin-wall section)

212E: Fixing section (edge)

212F: Fixing section (edge)

213: Intermediate air layer (air layer)

What is claimed is:

1. A luggage side trim comprising:
an interior-side front surface layer included in an interior-side surface;
a panel-side back surface layer that is included in a surface on a side of an inner panel and has an edge that is fixed to the interior-side front surface layer; and
an air layer interposed between the interior-side front surface layer and the panel-side back surface layer, wherein
the panel-side back surface layer is a molded article including a layer of an air-permeable base material,
the panel-side back surface layer includes:
a thick-wall section where the air-permeable base material is partially thickened; and
a thin-wall section where the air-permeable base material is partially thinned,
an opening is formed through the inner panel,
the thick-wall section is disposed facing the opening, and
the thin-wall section is disposed facing a wheelhouse panel or a drafter.

2. The luggage side trim according to claim 1, wherein the panel-side back surface layer includes a duct wall section included in a duct together with the inner panel, a wheelhouse panel, or a floor panel.

3. The luggage side trim according to claim 1, wherein the thick-wall section has greater air permeability of the air-permeable base material than the thin-wall section.

4. The luggage side trim according to claim 1, wherein the panel-side back surface layer includes an uneven section that is provided at a boundary between the thick-wall section and the thin-wall section and is concave in a direction away from the inner panel.

5. The luggage side trim according to claim 1, wherein the panel-side back surface layer has a difference in area density of the air-permeable base material between an interior side and a side of the inner panel.

6. The luggage side trim according to claim 1, wherein the interior-side front surface layer is a molded article including a layer of an air-impermeable base material.

7. A luggage side trim comprising:
an interior-side front surface layer included in an interior-side surface;
a panel-side back surface layer that is included in a surface on a side of an inner panel and has an edge that is fixed to the interior-side front surface layer; and
an air layer interposed between the interior-side front surface layer and the panel-side back surface layer, wherein
the panel-side back surface layer is a molded article including a layer of an air-permeable base material,
the panel-side back surface layer includes:
a thick-wall section where the air-permeable base material is partially thickened; and
a thin-wall section where the air-permeable base material is partially thinned, and
the thick-wall section has greater air permeability of the air-permeable base material than the thin-wall section.

8. A luggage side trim comprising:
an interior-side front surface layer included in an interior-side surface;
a panel-side back surface layer that is included in a surface on a side of an inner panel and has an edge that is fixed to the interior-side front surface layer; and
an air layer interposed between the interior-side front surface layer and the panel-side back surface layer, wherein
the panel-side back surface layer is a molded article including a layer of an air-permeable base material,
the panel-side back surface layer includes:
a thick-wall section where the air-permeable base material is partially thickened; and
a thin-wall section where the air-permeable base material is partially thinned, and
the panel-side back surface layer includes an uneven section that is provided at a boundary between the thick-wall section and the thin-wall section and is concave in a direction away from the inner panel.
